(19) United States
(12) Patent Application Publication
(10) Pub. No.: US 2015/0039472 A1
(43) Pub. Date: Feb. 5, 2015

(54) METHOD AND SYSTEM FOR SELECTING AND PRICING MEDIA CONTENT

(71) Applicant: Mark John Tryder, Wellesley, MA (US)

(72) Inventor: Mark John Tryder, Wellesley, MA (US)

(21) Appl. No.: 13/958,513

(22) Filed: Aug. 2, 2013

(51) Int. Cl. G06Q 30/06

(52) U.S. Cl. CPC G06Q 30/0623
USPC 705/26.61

(57) ABSTRACT

A media sourcing solution allows consumers to gain access to media content through several different sources. Currently, media consumers are without a means for understanding the most cost beneficial method to access their desired media content. The system and method can inform consumers as to where they can source their desired media content selection(s) for the most competitive pricing. The consumer will then have the ability to compare pricing and modify content usage to allow for the most informed media content sourcing decision making. An interface, such as a web-based interface or a mobile device application, can interact with a media content database to provide media source options to the consumer, saving the user time and money in the process.

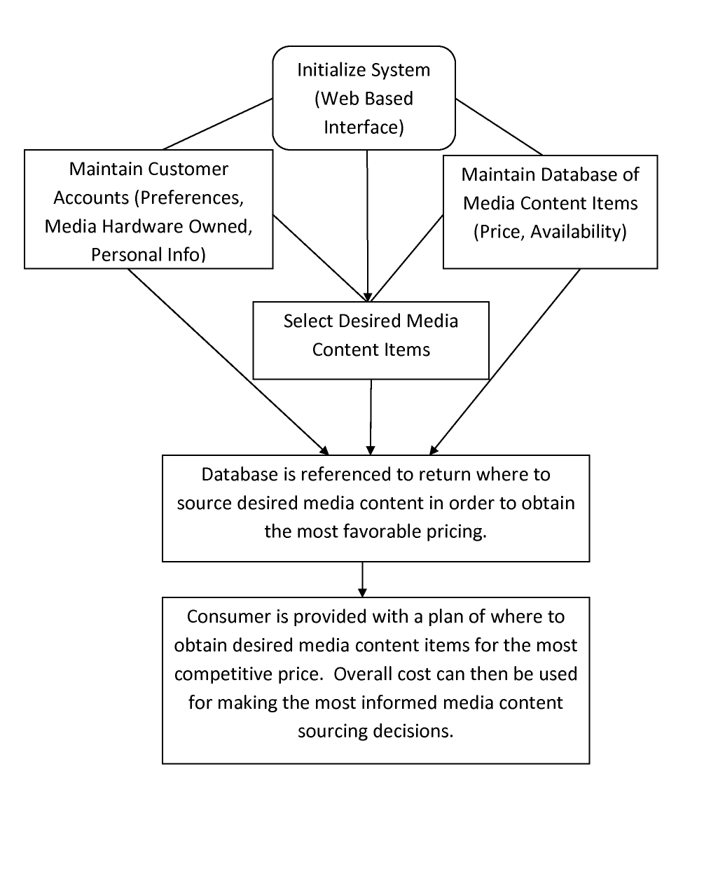

### BACKGROUND OF THE INVENTION

The present invention relates to media content organization and, more particularly, to methods and systems for selecting and pricing media items to allow for more informed decision making.

Consumers are able to gain access to media content through several different sources, but are without a means for understanding the most cost beneficial method to do so.

In many areas of the country, a consumer's television viewing is limited to either an over-the-air antenna, or to their local (often only) cable television provider. Where there is little or no competition, pricing for television programming can increase based on demand. While satellite dish services have placed some competition on cable television providers, satellite dish services do have their own set of limitations. Moreover, often the cost of satellite dish services rivals that of cable television providers.

Technological advances have made it totally plausible for consumers to circumvent current cable television providers and lose little, if any, desired programming in the process. However, with several diverse sources of media content, many of which having different access hardware requirements, a consumer can have a difficult time finding desired programming outside of their cable television provider. Moreover, it can take several hours to track down the desired programming and it could take an even greater amount of time and effort to determine if it is worth reducing or eliminating their cable television provider in favor of getting media programming from “alternative” sources.

As can be seen, there is a need for methods and systems for accessing media content through several different sources.

### SUMMARY OF THE INVENTION

In one aspect of the present invention, a system for sourcing media content comprises a first database for storing consumer information, the consumer information including desired media content; a second database for storing media content sourcing information; and a user interface providing an output to a user, the output including one or more options for sourcing desired media content from the media content sourcing information, including price and availability information for each option.

In another aspect of the present invention, a method for obtaining cost analysis of media content comprises entering desired media content into a first database, the first database storing consumer information; comparing the desired media content to data in a second database for storing media content sourcing information; and providing an output to a user, the output including one or more options for sourcing desired media content from the media content sourcing information, including price and availability information for each option.

These and other features, aspects and advantages of the present invention will become better understood with reference to the following drawings, description and claims.

### BRIEF DESCRIPTION OF THE DRAWING

The FIGURE is a flow chart describing a system and method for obtaining desired media content according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method that allows consumers to gain access to media content through several different sources but are without a means for understanding the most cost beneficial method to do so. The system and method can inform consumers as to where they can source their desired media content selection(s) for the most competitive pricing. The consumer will then have the ability to compare pricing and modify content usage to allow for the most informed media content sourcing decision making. An interface, such as a web-based interface or a mobile device application, can interact with a media content database to provide media source options to the consumer, saving the user time and money in the process.

Referring now to the FIGURE, a user can initialize the system of the present invention by, for example, logging into a website to access a consumer interface. In some embodiments, the consumer interface can be accessed by a mobile device application, such as a smartphone application. The user (consumer) can set up their account by providing information about the hardware they currently own, hardware they would be willing to own, media content providers to which they currently subscribe, if any, and the media content they desire to access.

The user information input by the consumer can be relayed to a database that contains logic that will return, based on all information provided, the most price competitive method for the consumer to gain access to all of their desired media content. The database can include details on various media content providers, such as Apple TV, Hulu, Netflix, Amazon video, and the like. The database can also include details of the local cable television provider and their packages and rates. The database can be updated often, such as daily, with the offerings of the various media content providers.

If the desired media content is offered “free” from a particular source, that source will be chosen if the user currently has access thereto. If there is a fee for hardware to access this source, the hardware can be amortized over 5 to 7 years, for example, to determine the monthly cost for access.

The system of the present invention can output a plan of where to obtain desired media content items for the most competitive price. The system may include directions or additional media hardware that must be obtained to gain access to the most favorable pricing on media items. This overall cost can be used for making the most informed media content sourcing decision.

In some embodiments, the system can provide options to the user that may include a time delay before the media programming is available. For example, if a certain television series is available on basic cable at a cost of $30.00 per month, and will also be available on Hulu® at the conclusion of the series, for $8.00 per month, the user can be provided the option for the more favorable pricing, but would also be provided with the time they must wait for viewing the programming. Likewise, if the user's desired content includes a series that would air on Showtime®, and they only have one such content item on that network, the user can be provided the option to watch that programming “live” for the cost of a subscription to that premium channel, or perhaps an alternative content provider may provide the same episodes, a week late, for a different subscription fee. In each of these cases the user can be provided the options for both time and cost to make the most informed decision.

In some embodiments, the system can “learn” past options and provide the possibility of a future option for content sourcing based on past performance. In other words, if the cost of a subscription to Showtime® for 6 months would cost $60 to watch one show for the 2013 season, and the entire 2012 season became available on Amazon video for $49 one month after the last episode of the 2012 season aired, the system would remember this detail and provide the possibility that the current 2013 season would also be available for a similar price at a similar time after the conclusion thereof. This provides an additional level of service, where consumers can weigh the cost of being able to watch content immediately versus the value of waiting a certain period of time.

The system of the present invention can include a database for storing media content sourcing information and an interface that allows users to access the data. The system further includes a database for storing consumer information, including subscription information, desired content information, hardware information, and the like. Finally, the system includes the appropriate logic to compare the consumer information to the media content sourcing information to output options for obtaining the desired content.

While a web interface or a smartphone interface is described herein, other interfaces may be used to access the system of the present invention. For example, a smart television could be established with a consumer interface, allowing the consumer to add content to their desired content (for example, as they are watching that content), program their consumer information, and view the output of the options.

It should be understood, of course, that the foregoing relates to exemplary embodiments of the invention and that modifications may be made without departing from the spirit and scope of the invention as set forth in the following claims.

What is claimed is:

1. A system for sourcing media content, the system comprising:
a first database for storing consumer information, the consumer information including desired media content;
a second database for storing media content sourcing information; and
a user interface providing an output to a user, the output including one or more options for sourcing desired media content from the media content sourcing information, including price and availability information for each option.

2. The system of claim 1, wherein the consumer information includes user preferences, media hardware owned, personal information, and media subscription information.

3. The system of claim 1, wherein the media content sourcing information includes content availability information and media pricing information.

4. The system of claim 1, wherein the consumer information includes current media sourcing cost for the user and the output provides a comparison of the current media sourcing cost to each of the one or more options.

5. A method for obtaining cost analysis of media content, the method comprising:
entering desired media content into a first database, the first database storing consumer information;
comparing the desired media content to data in a second database for storing media content sourcing information; and
providing an output to a user, the output including one or more options for sourcing desired media content from the media content sourcing information, including price and availability information for each option.

6. The method of claim 5, wherein the consumer information includes user preferences, media hardware owned, personal information, and media subscription information.

7. The method of claim 5, wherein the media content sourcing information includes content availability information and media pricing information.

8. The method of claim 5, wherein the consumer information includes current media sourcing cost for the user and the output provides a comparison of the current media sourcing cost to each of the one or more options.

9. The method of claim 5, further comprising providing historical data to the user as one or more options for sourcing desired media content.
